(19) United States
(12) Patent Application Publication
(10) Pub. No.: US 2008/0173628 A1
(43) Pub. Date: Jul. 24, 2008

(54) HEATING SYSTEM FOR MOTOR VEHICLES

(76) Inventors: Christian Dorrie, Herxheim (DE); Frank Bartmann, Hambrucken (DE); Norbert Ernst, Billigheim-Ingenheim (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/015,386

(22) Filed: Jan. 16, 2008

(30) Foreign Application Priority Data
Jan. 18, 2007 (DE) 20 2007 001 079.6

(51) Int. Cl. B60L 1/02; H01R 13/648

(52) U.S. Cl. 219/202; 439/92

(57) ABSTRACT

The invention refers to a motor vehicle heating system comprising several heating elements, several voltage connectors for connecting the heating elements to a supply voltage, and a plug-on connector receptacle in which the voltage connectors are arranged as contact reeds. According to the invention the plug-in connector receptacle is provided with a ground pin for connecting of the motor vehicle heating system to ground.

The invention relates to a heating system for a motor vehicle with the features set forth in the preamble of claim 1. By way of example, such a heating system for a motor vehicle is known from EP 1 432 287 A1.

Electric heating systems are used for the heating of the passenger compartment in motor vehicles. Especially in the case of very fuel-efficient diesel engines, the waste heat of the engine does not suffice, particularly at freezing temperatures, to heat within a short period of time the passenger compartment to a pleasant temperature. Because of this, motor vehicles are equipped with electric motor vehicle heating systems.

When designing the heating systems for motor vehicles, attention must be paid to the following requirements:

The heating power must be as high as possible so that the passenger compartment of the motor vehicle can be heated within the shortest period of time; the motor vehicle heating system, including its required connections, shall be as small and compact as possible; the manufacture shall be as cost-effective as possible and the installation of the assembled heating system in a motor vehicle should be carried out with the least possible effort.

The motor vehicle heating system known from EP 1 432 287 A1 has a plug-in connector receptacle with five contact reeds as voltage and earth connections (3 voltage and 2 earth connections). Therefore, with an appropriate plug-in connector, this motor vehicle heating system can be rapidly and easily connected to the electrical system of a motor vehicle. However, the contacts established in such a manner are suitable only for up to about 100 A, so that the heating power of such a motor vehicle heating system is limited to about 1 kW.

### SUMMARY OF THE INVENTION

The object of the invention is to show a manner in which the design requirements for the highest possible heating power, a reduced space for the installation, low manufacturing costs, and a simple assembly could be met as satisfactorily as possible.

According to the invention, this object is achieved by providing the plug-in connector receptacle with a ground pin for the connecting of the motor vehicle heating system to ground.

In view that the plug-in connector receptacle of a motor vehicle heating system is provided with voltage connectors in the form of contact reeds, different principles are used to connect the motor vehicle heating system to voltage and ground. The advantages for a quick and easy assembly, associated with contact reeds and a plug-in connector receptacle, can be used for the voltage connections. Insofar as for the ground connection a ground pin is used instead of contact reeds, it is possible to handle considerably higher currents, so that the heating power can be increased. In the case of the motor vehicle heating system known from the EP 1 432 287 A1, a comparably increased output could be attained only through the use of additional contact reeds for additional ground connections to the vehicle body and, thus, an increased space for installation.

Because of the ground pin of a motor vehicle heating system, according to the invention, it is possible to convey considerably higher currents than by means of contact reeds, so that in the case of a motor vehicle heating system, according to the invention, a single ground pin suffices and, in spite of a small and compact design, it is possible to obtain considerably higher current intensities and, therefore, higher heating power.

For the connecting of a motor vehicle heating system, according to the invention, it is possible to use a plug-in connector which, in addition to female recesses for the contact reeds of the voltage connections, is also provided with a socket for the contacting of the ground pin. A motor vehicle heating system, according to the invention, offers also the advantage to uncouple the contacting of the voltage connectors from the contacting of the ground pin by using a plug-in connector that has a through-hole through which the ground pin protrudes when the plug-in connector is inserted in the plug-in connector receptacle. Then the ground pin can be separately connected to a ground connection. An interlocking connection is especially favorable for this; by way of example, the ground pin can be threaded so that a lug, held by the nut, of a ground connection cable can be used for the ground connection.

The possibility of an uncoupling of the voltage connections from the ground connection is very advantageous for the motor vehicle heating system, according to the invention, because the pertinent assembly steps can be performed independently of each other. This is especially of great advantage when the connecting cables of the motor vehicle heating system, according to the invention, have to be bundled to a cable harness with the connecting cables of other components of the vehicle such as, e.g., an air conditioner.

A motor vehicle heating system according to the invention may comprise a voltage connection cable that is connected at its end to a plug-in connector that fits the plug-in connector receptacle of the motor vehicle heating system. The plug-in connector of a heating system of such type is preferably connected to several voltage connection cables, each of which, during operation, is connected to one of the voltage connectors. The voltage connectors configured as contact reeds are preferably suitable for the plug-in connector system TYCO AMP MCP (multiple contact point) system (6.3/4.8K).

The ground pin is preferably arranged in a row with the contact reeds since in this manner the connecting of the motor vehicle heating system to the electrical system of a motor vehicle can be performed in a particularly space-saving manner. For this, it is not absolutely necessary that the geometric central axis of the ground pin is in geometrically exact alignment with the contact reeds. For a space-saving design it suffices that the geometric central axis of the ground pin is at a distance of not more than 10 mm from the straight line running through the centers of the two nearest contact reeds. Preferably, the distance of the geometric central axis from this straight line is less than 8 mm, especially favorable less than 5 mm, and most favorable less than 3 mm.

### BRIEF DESCRIPTION OF THE DRAWINGS

Further details and advantages of the invention are explained by means of an embodiment making reference to the accompanying drawings. The therein described features can separately or combined be made the object of claims.

FIG. 1 shows an embodiment of a motor vehicle heating system with attached plug-in connector and ground connection cable;

FIG. 2 shows a sectional view of FIG. 1;

FIG. 3 shows a view in the connector direction of the motor vehicle heating system without the plug-in connector;

FIG. 4 shows a diagonal view of the plug-in connector receptacle of the motor vehicle heating system;

FIG. 5 shows another diagonal view of the plug-in connector receptacle;

FIG. 6 shows an embodiment of a plug-in connector suitable for the illustrated plug-in connector receptacle;

FIG. 7 shows in another view the plug-in connector illustrated in FIG. 6 with the ground connection.

### DETAILED DESCRIPTION

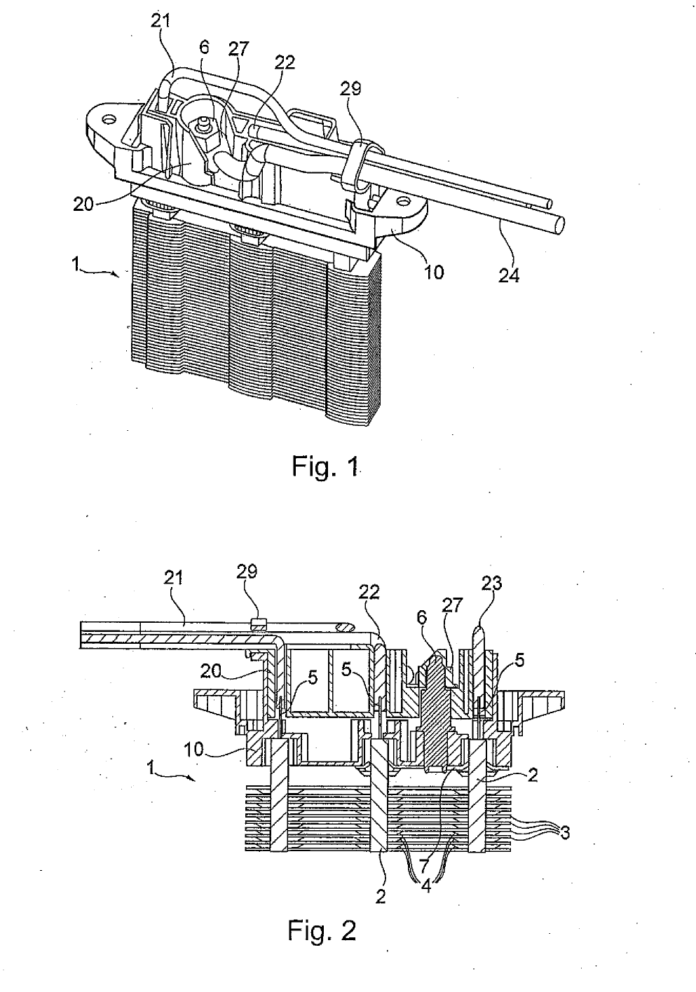

The motor vehicle heating system 1 illustrated in FIGS. 1 and 2 has several, i. e. three, heating rods 2 in each of which is arranged at least one PTC heating element. Heat emission elements 3 are slipped onto the heating rods 2. In operation the heat emission elements 3, absorb heat generated by the heating rods 2 and dissipate it to the ambient air. In the illustrated embodiment, the heat emission elements 3 are configured as metal sheets into which apertures are punched through which the heating rods 2 are pushed. In this embodiment, tongues 4 are bent from the heat emission elements 3.

From each of the heating rods 2 protrudes a voltage connector 5 in the form of a contact reed by means of which the PTC heating elements can be provided with voltage. As specified, the outsides of the heating rods 2 are grounded. For this is provided a ground pin 6 that is affixed to a metal contact sheet 7, e.g., by riveting or soldering, that has openings through each of which projects one of the heating rods 2, contacting in such a manner the metal contact sheet 7. In the illustrated embodiment, only two heating rods 2 are pushed through the openings of the metal contact sheet 7. The third heating element 2 is electrically connected by means of the heat emission elements 3 to the other heating rods 2 and, thus, also to the ground pin 6.

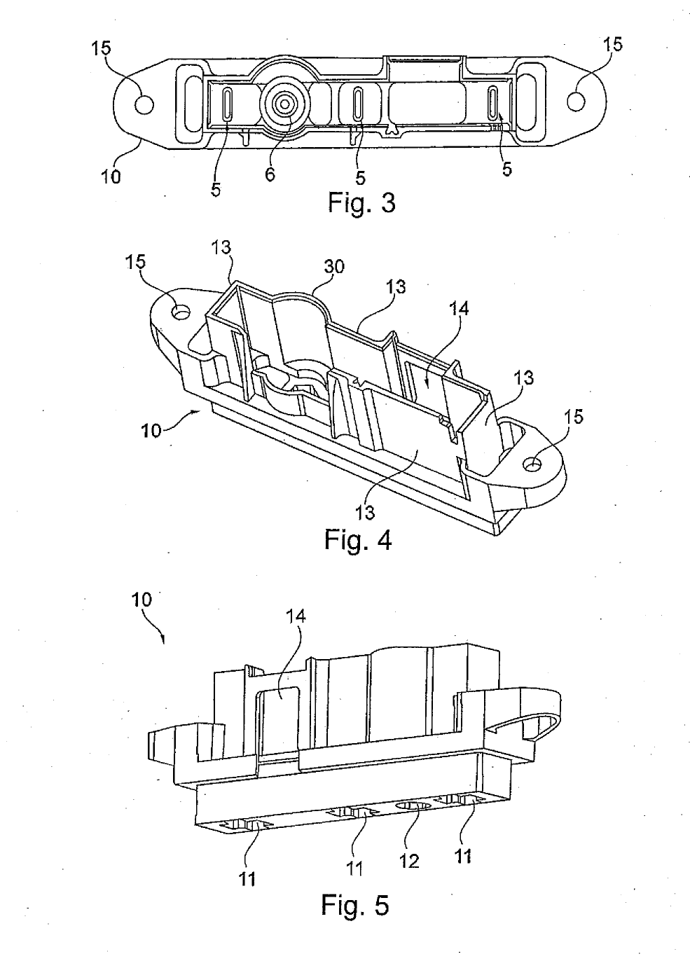

The motor vehicle heating system 1 has a plug-in connector receptacle 10, especially illustrated in FIGS. 3 to 5, in which are inserted in a row the contact reeds 5, protruding from the heating rods 2, as well as the ground pin 6. Therein, the cylindrical ground pin 6 is arranged between two contact reeds 5. The plug-in connector receptacle 10 of the illustrated embodiment is an injection molded part that on its underside is provided with openings 11, shown in FIG. 5, wherein are arranged heating rods 2. As shown in the sectional view of FIG. 2, these openings 11 narrow, so that the plug-in connector receptacle 10 rests on the heating rods 2 and the contact reeds 5 jut out from the bottom of the plug-in connector receptacle 10. The bottom of the plug-in connector receptacle 10 is also provided with a cutout 12, through which extends the ground pin 6.

The plug-in connector receptacle 10 is provided with a mechanical limit stop with mounting holes 15 and it has lateral walls 13 that enclose an interior space in which are arranged the voltage connectors 5 and the ground pin 6. Preferably, at last one of these lateral walls is provided with a catch recess 14 for a projection, in particular an elastic locking latch, of a plug-in connector.

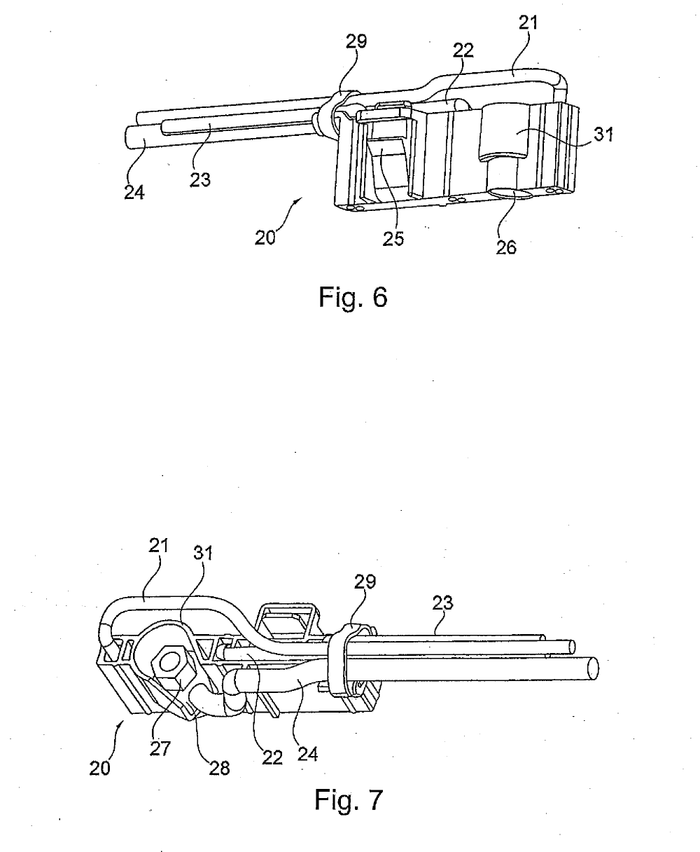

The FIGS. 6 and 7 illustrate the appropriate plug-in connector 20 for the plug-in connector receptacle 10 with the voltage leads 21, 22, 23 and the ground connection cable 24. Especially in FIG. 6 can be recognized the locking latch 25, mentioned in above paragraph, that engages, as intended, in the catch recess 14 of the plug-in connector receptacle 10.

In the illustrated embodiment, every contact reed 5 is connected to a voltage connecting cable 21, 22, 23 by means of the plug-in connector 20.

A particularity of the illustrated embodiment is that although the plug-in connector 20 effectuates the connection of the contact reeds 5 to the voltage leads 21, 22, 23 it does not connect the ground pin 6 to ground, i. e the vehicle body. As especially shown in FIG. 2, the plug-in connector 20 is provided with a through-hole 26 through which the ground pin 6 protrudes when the plug-in connector 20 is inserted into the plug-in connector receptacle. Therefore, the plug-in connector 20 of the illustrated embodiment connects only the voltage connectors 5 but not the ground pin 6.

The ground pin 6 is connected to earth by means of the ground connection cable 24 that is not connected to electric contacts of the plug-in connector 20. The ground pin 6 has a structured outside contour for a positive locking with the ground connection. In the illustrated embodiment, the structured outside contour is an outside thread that interacts with a terminal nut 27 (see FIGS. 1 and 7) in order to secure a lug 28 of the ground connection cable 24 that surrounds the ground pin 6. By way of example, the structured outer contour can also be configured as an annular groove in order to establish a positive locking with a connection socket. Such a connection socket for the ground cable can be configured, e.g., as a so-called Radsock-contact.

The plug-in connector receptacle 10 as well as the plug-in connector 20 are provided with a cutout for the ground connection cable 24. The ground connection cable 24 is led through cutouts and, together with the voltage leads 21, 22, 23 is held by a cable duct 29 of the plug-in connector 20. The plug-in connector receptacle 10 and the thereto matching plug-in connector 20 are each provided with a lateral salient 30, 31 that is opposite the groove for the ground connection cable 24. This measure has the advantage that space is generated in order to easily screw the terminal nut 27 onto the outer thread of the ground pin 6.

### REFERENCE NUMBERS LIST

1 Heating system for a motor vehicle

2 Heating rods

3 Heat emission element

4 Tongues

5 Voltage connectors

6 Ground pin

7 Metal contact sheet

10 Plug-on connector receptacle

11 Opening

12 Cutout

13 Lateral wall

14 Catch recess

15 Mounting hole

20 Plug-in connector

21 Voltage leads

22 Voltage leads

23 Voltage leads

24 Ground connection cable

25 Locking latch

26 Through-hole

27 Terminal nut

28 Lug

29 Cable duct

30 Salient

31 Salient

What is claimed is:

1. A motor vehicle heating system comprising
a plurality of heating elements,
a plurality of voltage connectors for connecting the heating elements to a supply voltage, and
a plug-in connector receptacle in which the voltage connectors are arranged as contact reeds, the plug-in connector receptacle having a ground pin for connecting of the motor vehicle heating system to ground.

2. The motor vehicle heating system according to claim 1, wherein the ground pin extends farther than the contact reeds in a direction of the plug-in connection.

3. The motor vehicle heating system according to claim 1, wherein the plug-in connector receptacle includes one ground pin.

4. The motor vehicle heating system according to claim 1, the plug-in connector receptacle includes at least three contact reeds.

5. The motor vehicle heating system according to claim 1, wherein the ground pin has a structured outside contour for a positive locking with a ground connection.

6. The motor vehicle heating system according to claim 1, wherein the ground pin is threaded.

7. The motor vehicle heating system according to claim 5, wherein the ground pin includes an annular groove.

8. The motor vehicle heating system according to claim 1, wherein the plug-in connector receptacle comprises a mechanical limit stop with mounting holes.

9. The motor vehicle heating system according to claim 1, wherein the plug-in connector receptacle includes lateral walls enclosing an interior space, the voltage connectors and the ground pin being disposed in the interior space.

10. The motor vehicle heating system according to claim 1, wherein the plug-on connector receptacle includes a lateral cutout for a ground connection cable.

11. The motor vehicle heating system according to claim 10, wherein the plug-in connector receptacle includes a salient on a lateral wall opposite to the cutout.

12. The motor vehicle heating system according to claim 9, wherein the plug-in connector receptacle includes a bottom having openings on an underside thereof for receiving the heating elements.

13. The motor vehicle heating system according to claim 1, wherein the plug-in connector receptacle has a lateral wall with a catch recess for a plug-in connector locking latch.

14. The motor vehicle heating system according to claim 1, wherein the ground pin is disposed between two contact reeds.

15. The motor vehicle heating system according to claim 1, wherein the ground pin and the contact reeds are aligned in a row.

16. The motor vehicle heating system according to claim 1, wherein the ground pin is affixed to a metal contact sheet having at least two cutouts, each cutout enabling one of the heating elements to extend threrethrough in order to contact the metal contact sheet.

17. The heating system according to claim 1 comprising a voltage cable with a plug-in connector at an end thereof for fitting into the plug-in connector receptacle of the motor vehicle heating system.

18. The heating system according to claim 17, wherein a plurality of voltage connection cables are connected to the plug-in connector.

19. The heating system according to claim 17, wherein the plug-in connector includes a through-hole, the ground pin extending through the through-hole when the plug-in connector is inserted into the plug-in connector receptacle.

20. The heating system according to claim 17, wherein the plug-in connector includes a socket for the contacting the ground pin.

21. The heating system according to claim 17, wherein the plug-in connector includes a cable duct.
